(19) United States
(12) Patent Application Publication
(10) Pub. No.: US 2009/0217321 A1
(43) Pub. Date: Aug. 27, 2009

(54) SYSTEM AND METHOD FOR CONDUCTING CHARITABLE ACTIVITIES

(75) Inventor: SCOTT WHITE, Austin, TX (US)

Correspondence Address: AT&T Legal Department - AS;Attn: Patent Docketing, Room 2A-207, One AT&T Way, Bedminster, NJ, 07921, US

(73) Assignee: AT&T KNOWLEDGE VENTURES, L.P., RENO, NV (US)

(21) Appl. No.: 12/037,767

(22) Filed: Feb. 26, 2008

(51) Int. Cl. G06F 3/00

(52) U.S. Cl. 725/37

(57) ABSTRACT

A system that incorporates teachings of the present disclosure may include, for example, a set top box (STB) operating in an interactive television communication system having a controller to receive metadata describing a charitable media program associated with a charitable organization, present images of the charitable media program and a selectable graphical user interface (GUI) element, detect a transition event in the presentation of the charitable media program according to the metadata or a selection of the GUI element, and present a GUI to enable a viewer to make a charitable contribution by way of the STB. Other embodiments are disclosed.

### FIELD OF THE DISCLOSURE

The present disclosure relates generally to charitable activities and more specifically to a system and method for conducting charitable activities.

### BACKGROUND

Some charitable organizations seek contributions by presenting charitable programs on broadcast television (TV) stations. Charitable organizations utilizing this technique typically receive contributions from viewers who dial into a telephone number presented by the TV program promoting their charitable activity.

### BRIEF DESCRIPTION OF THE DRAWINGS

FIGS. 1-4 depict exemplary embodiments of communication systems that provide media services;

FIG. 5 depicts an exemplary embodiment of a portal interacting with at least one among the communication systems of FIGS. 1-4;

FIG. 6 depicts an exemplary method operating in portions of the communication systems of FIGS. 1-4;

FIGS. 7-16 depict exemplary images illustrating in part the method of FIG. 6; and

FIG. 17 is a diagrammatic representation of a machine in the form of a computer system within which a set of instructions, when executed, may cause the machine to perform any one or more of the methodologies discussed herein.

### DETAILED DESCRIPTION

One embodiment of the present disclosure entails a set top box (STB) operating in an interactive television communication system having a controller to receive metadata describing a charitable media program associated with a charitable organization, present images of the charitable media program and a selectable graphical user interface (GUI) element, detect a transition event in the presentation of the charitable media program according to the metadata or a selection of the GUI element, and present a GUI to enable a viewer to make a charitable contribution by way of the STB.

Another embodiment of the present disclosure entails a charity management system having a controller to collect metadata of a charitable media program associated with a charitable organization, distribute the metadata to one or more media processors operating in an interactive television communication system to facilitate presentation of an interactive charitable contribution graphical user interface, receive from one of the media processors a request to make a contribution to the charitable organization, identify a subscriber account of the requesting media processor, submit one or more payments to the charitable organization, and record the one or more payments in the subscriber account.

Yet another embodiment of the present disclosure entails a method involving a charitable organization receiving a charitable contribution from a subscriber account of an interactive television communication system

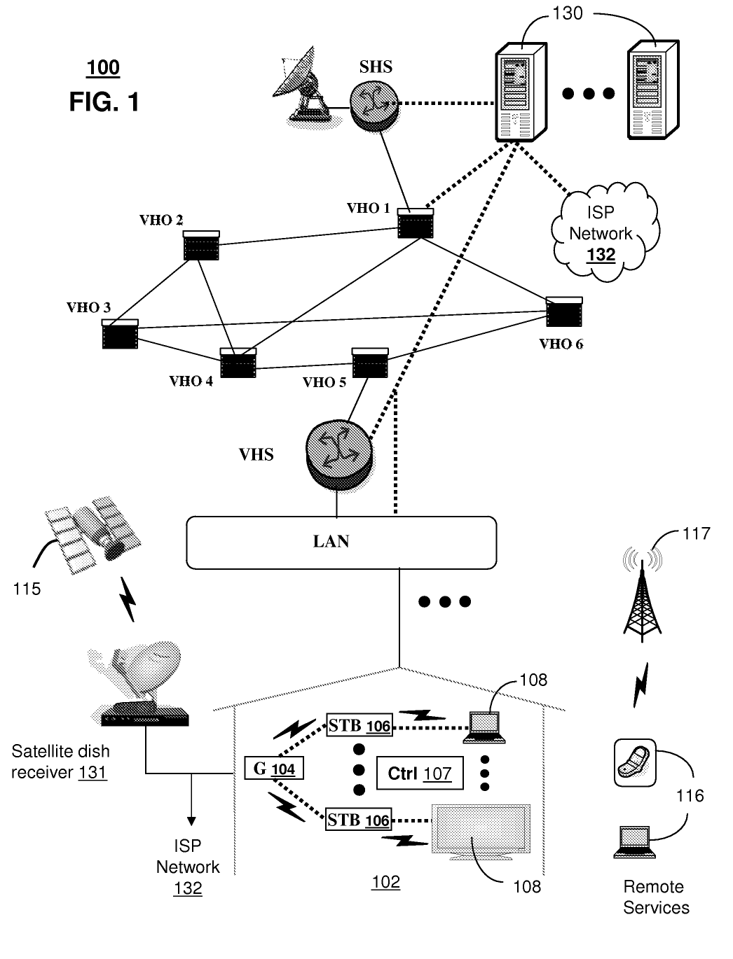

FIG. 1 depicts an exemplary embodiment of a first communication system 100 for delivering media content. The communication system 100 can represent an Internet Protocol Television (IPTV) broadcast media system. In a typical IPTV infrastructure, there is at least one super head-end office server (SHS) which receives national media programs from satellite and/or media servers from service providers of multimedia broadcast channels. In the present context, media programs can represent audio content, moving image content such as videos, still image content, and/or combinations thereof. The SHS server forwards IP packets associated with the media content to video head-end servers (VHS) via a network of aggregation points such as video head-end offices (VHO) according to a common multicast communication method.

The VHS then distributes multimedia broadcast programs via a local area network (LAN) to commercial and/or residential buildings 102 housing a gateway 104 (e.g., a residential gateway or RG). The LAN can represent a bank of digital subscriber line access multiplexers (DSLAMs) located in a central office or a service area interface that provide broadband services over optical links or copper twisted pairs to buildings 102. The gateway 104 distributes broadcast signals to media processors 106 such as STBs which in turn present broadcast selections to media devices 108 such as computers or television sets managed in some instances by a media controller 107 (e.g., an infrared or RF remote control). Unicast traffic can also be exchanged between the media processors 106 and subsystems of the IPTV media system for services such as video-on-demand (VoD). It will be appreciated by one of ordinary skill in the art that the media devices 108 and/or portable communication devices 116 shown in FIG. 1 can be an integral part of the media processor 106 and can be communicatively coupled to the gateway 104. In this particular embodiment, an integral device such as described can receive, respond, process and present multicast or unicast media content.

The IPTV media system can be coupled to one or more computing devices 130 a portion of which can operate as a web server for providing portal services over an Internet Service Provider (ISP) network 132 to fixed line media devices 108 or portable communication devices 116 by way of a wireless access point 117 providing Wireless Fidelity or WiFi services, or cellular communication services (e.g., GSM, CDMA, UMTS, WiMAX, etc.). Another distinct portion of the one or more computing devices 130 can be used as a charity management system 130 for managing charitable contributions of subscribers of the media communication system 100.

A satellite broadcast television system can be used in place of the IPTV media system. In this embodiment, signals transmitted by a satellite 115 can be intercepted by a satellite dish receiver 131 coupled to building 102 which conveys media signals to the media processors 106. The media receivers 106 can be equipped with a broadband port to the ISP network 132. Although not shown, the communication system 100 can also be combined or replaced with analog or digital broadcast distributions systems such as cable TV systems.

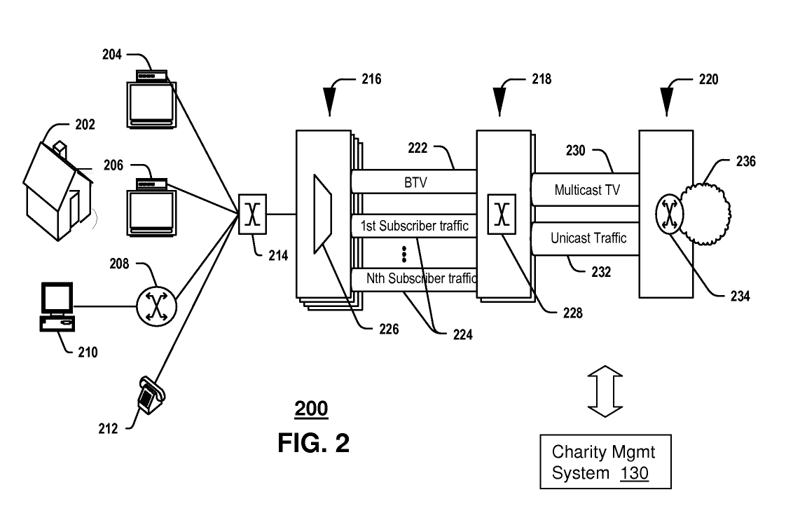

FIG. 2 depicts an exemplary embodiment of a second communication system 200 for delivering media content. Communication system 200 can be overlaid or operably coupled with communication system 100 as another representative embodiment of said communication system. The system 200 includes a distribution switch/router system 228 at a central office 218. The distribution switch/router system 228 receives video data via a multicast television stream 230 from a second distribution switch/router 234 at an intermediate office 220. The multicast television stream 230 includes Internet Protocol (IP) data packets addressed to a multicast IP address associated with a television channel. The distribution switch/router system 228 can cache data associated with each television channel received from the intermediate office 220.

The distribution switch/router system 228 also receives unicast data traffic from the intermediate office 220 via a unicast traffic stream 232. The unicast traffic stream 232 includes data packets related to devices located at a particular residence, such as the residence 202. For example, the unicast traffic stream 232 can include data traffic related to a digital subscriber line, a telephone line, another data connection, or any combination thereof. To illustrate, the unicast traffic stream 232 can communicate data packets to and from a telephone 212 associated with a subscriber at the residence 202. The telephone 212 can be a Voice over Internet Protocol (VoIP) telephone. To further illustrate, the unicast traffic stream 232 can communicate data packets to and from a personal computer 210 at the residence 202 via one or more data routers 208. In an additional illustration, the unicast traffic stream 232 can communicate data packets to and from a set-top box device, such as the set-top box devices 204, 206. The unicast traffic stream 232 can communicate data packets to and from the devices located at the residence 202 via one or more residential gateways 214 associated with the residence 202.

The distribution switch/router system 228 can send data to one or more access switch/router systems 226. The access switch/router system 226 can include or be included within a service area interface 216. In a particular embodiment, the access switch/router system 226 can include a DSLAM. The access switch/router system 226 can receive data from the distribution switch/router system 228 via a broadcast television (BTV) stream 222 and a plurality of unicast subscriber traffic streams 224. The BTV stream 222 can be used to communicate video data packets associated with a multicast stream.

For example, the BTV stream 222 can include a multicast virtual local area network (VLAN) connection between the distribution switch/router system 228 and the access switch/router system 226. Each of the plurality of subscriber traffic streams 224 can be used to communicate subscriber specific data packets. For example, the first subscriber traffic stream can communicate data related to a first subscriber, and the nth subscriber traffic stream can communicate data related to an nth subscriber. Each subscriber to the system 200 can be associated with a respective subscriber traffic stream 224. The subscriber traffic stream 224 can include a subscriber VLAN connection between the distribution switch/router system 228 and the access switch/router system 226 that is associated with a particular set-top box device 204, 206, a particular residence 202, a particular residential gateway 214, another device associated with a subscriber, or any combination thereof.

In an illustrative embodiment, a set-top box device, such as the set-top box device 204, receives a channel change command from an input device, such as a remoter control device. The channel change command can indicate selection of an IPTV channel. After receiving the channel change command, the set-top box device 204 generates channel selection data that indicates the selection of the IPTV channel. The set-top box device 204 can send the channel selection data to the access switch/router system 226 via the residential gateway 214. The channel selection data can include an Internet Group Management Protocol (IGMP) Join request. In an illustrative embodiment, the access switch/router system 226 can identify whether it is joined to a multicast group associated with the requested channel based on information in the IGMP Join request.

If the access switch/router system 226 is not joined to the multicast group associated with the requested channel, the access switch/router system 226 can generate a multicast stream request. The multicast stream request can be generated by modifying the received channel selection data. In an illustrative embodiment, the access switch/router system 226 can modify an IGMP Join request to produce a proxy IGMP Join request. The access switch/router system 226 can send the multicast stream request to the distribution switch/router system 228 via the BTV stream 222. In response to receiving the multicast stream request, the distribution switch/router system 228 can send a stream associated with the requested channel to the access switch/router system 226 via the BTV stream 222.

The charitable management system 130 of FIG. 1 can be operably coupled to the second communication system 200 for managing charitable contributions of the subscribers of the second communication system.

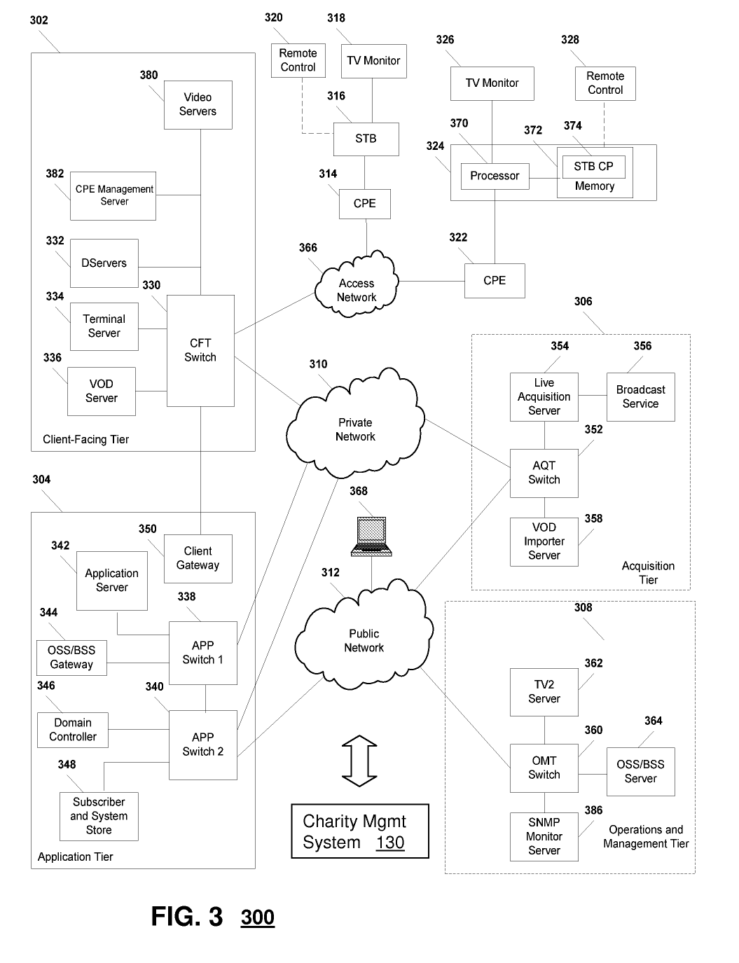

FIG. 3 depicts an exemplary embodiment of a third communication system 300 for delivering media content. Communication system 300 can be overlaid or operably coupled with communication systems 100-200 as another representative embodiment of said communication systems. As shown, the system 300 can include a client facing tier 302, an application tier 304, an acquisition tier 306, and an operations and management tier 308. Each tier 302, 304, 306, 308 is coupled to a private network 310, such as a network of common packet-switched routers and/or switches; to a public network 312, such as the Internet; or to both the private network 310 and the public network 312. For example, the client-facing tier 302 can be coupled to the private network 310. Further, the application tier 304 can be coupled to the private network 310 and to the public network 312. The acquisition tier 306 can also be coupled to the private network 310 and to the public network 312. Additionally, the operations and management tier 308 can be coupled to the public network 322.

As illustrated in FIG. 3, the various tiers 302, 304, 306, 308 communicate with each other via the private network 310 and the public network 312. For instance, the client-facing tier 302 can communicate with the application tier 304 and the acquisition tier 306 via the private network 310. The application tier 304 can communicate with the acquisition tier 306 via the private network 310. Further, the application tier 304 can communicate with the acquisition tier 306 and the operations and management tier 308 via the public network 312. Moreover, the acquisition tier 306 can communicate with the operations and management tier 308 via the public network 312. In a particular embodiment, elements of the application tier 304, including, but not limited to, a client gateway 350, can communicate directly with the client-facing tier 302.

The client-facing tier 302 can communicate with user equipment via an access network 366, such as an IPTV access network. In an illustrative embodiment, customer premises equipment (CPE) 314, 322 can be coupled to a local switch, router, or other device of the access network 366. The client-facing tier 302 can communicate with a first representative set-top box device 316 via the first CPE 314 and with a second representative set-top box device 324 via the second CPE 322. In a particular embodiment, the first representative set-top box device 316 and the first CPE 314 can be located at a first customer premise, and the second representative set-top box device 324 and the second CPE 322 can be located at a second customer premise.

In another particular embodiment, the first representative set-top box device 316 and the second representative set-top box device 324 can be located at a single customer premise, both coupled to one of the CPE 314, 322. The CPE 314, 322 can include routers, local area network devices, modems, such as digital subscriber line (DSL) modems, any other suitable devices for facilitating communication between a set-top box device and the access network 366, or any combination thereof.

In an exemplary embodiment, the client-facing tier 302 can be coupled to the CPE 314, 322 via fiber optic cables. In another exemplary embodiment, the CPE 314, 322 can include DSL modems that are coupled to one or more network nodes via twisted pairs, and the client-facing tier 302 can be coupled to the network nodes via fiber-optic cables. Each set-top box device 316, 324 can process data received via the access network 366, via a common IPTV software platform.

The first set-top box device 316 can be coupled to a first external display device, such as a first television monitor 318, and the second set-top box device 324 can be coupled to a second external display device, such as a second television monitor 326. Moreover, the first set-top box device 316 can communicate with a first remote control 320, and the second set-top box device 324 can communicate with a second remote control 328. The set-top box devices 316, 324 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 316, 324 can receive data, video, or any combination thereof, from the client-facing tier 302 via the access network 366 and render or display the data, video, or any combination thereof, at the display device 318, 326 to which it is coupled. In an illustrative embodiment, the set-top box devices 316, 324 can include tuners that receive and decode television programming signals or packet streams for transmission to the display devices 318, 326. Further, the set-top box devices 316, 324 can each include a STB processor 370 and a STB memory device 372 that is accessible to the STB processor 370. In one embodiment, a computer program, such as the STB computer program 374, can be embedded within the STB memory device 372.

In an illustrative embodiment, the client-facing tier 302 can include a client-facing tier (CFT) switch 330 that manages communication between the client-facing tier 302 and the access network 366 and between the client-facing tier 302 and the private network 310. As illustrated, the CFT switch 330 is coupled to one or more distribution servers, such as Distribution-servers (D-servers) 332, that store, format, encode, replicate, or otherwise manipulate or prepare video content for communication from the client-facing tier 302 to the set-top box devices 316, 324. The CFT switch 330 can also be coupled to a terminal server 334 that provides terminal devices with a point of connection to the IPTV system 300 via the client-facing tier 302.

In a particular embodiment, the CFT switch 330 can be coupled to a video-on-demand (VOD) server 336 that stores or provides VOD content imported by the IPTV system 300. Further, the CFT switch 330 is coupled to one or more video servers 380 that receive video content and transmit the content to the set-top boxes 316, 324 via the access network 366. The client-facing tier 302 may include a CPE management server 382 that manages communications to and from the CPE 314 and the CPE 322. For example, the CPE management server 382 may collect performance data associated with the set-top box devices 316, 324 from the CPE 314 or the CPE 322 and forward the collected performance data to a server associated with the operations and management tier 308.

In an illustrative embodiment, the client-facing tier 302 can communicate with a large number of set-top boxes, such as the representative set-top boxes 316, 324, over a wide geographic area, such as a metropolitan area, a viewing area, a statewide area, a regional area, a nationwide area or any other suitable geographic area, market area, or subscriber or customer group that can be supported by networking the client-facing tier 302 to numerous set-top box devices. In a particular embodiment, the CFT switch 330, or any portion thereof, can include a multicast router or switch that communicates with multiple set-top box devices via a multicast-enabled network.

As illustrated in FIG. 3, the application tier 304 can communicate with both the private network 310 and the public network 312. The application tier 304 can include a first application tier (APP) switch 338 and a second APP switch 340. In a particular embodiment, the first APP switch 338 can be coupled to the second APP switch 340. The first APP switch 338 can be coupled to an application server 342 and to an OSS/BSS gateway 344. In a particular embodiment, the application server 342 can provide applications to the set-top box devices 316, 324 via the access network 366, which enable the set-top box devices 316, 324 to provide functions, such as interactive program guides, video gaming, display, messaging, processing of VOD material and other IPTV content, etc. In an illustrative embodiment, the application server 342 can provide location information to the set-top box devices 316, 324. In a particular embodiment, the OSS/BSS gateway 344 includes operation systems and support (OSS) data, as well as billing systems and support (BSS) data. In one embodiment, the OSS/BSS gateway 344 can provide or restrict access to an OSS/BSS server 364 that stores operations and billing systems data.

The second APP switch 340 can be coupled to a domain controller 346 that provides Internet access, for example, to users at their computers 368 via the public network 312. For example, the domain controller 346 can provide remote Internet access to IPTV account information, e-mail, personalized Internet services, or other online services via the public network 312. In addition, the second APP switch 340 can be coupled to a subscriber and system store 348 that includes account information, such as account information that is associated with users who access the IPTV system 300 via the private network 310 or the public network 312. In an illustrative embodiment, the subscriber and system store 348 can store subscriber or customer data and create subscriber or customer profiles that are associated with IP addresses, stock-keeping unit (SKU) numbers, other identifiers, or any combination thereof, of corresponding set-top box devices 316, 324. In another illustrative embodiment, the subscriber and system store can store data associated with capabilities of set-top box devices associated with particular customers.

In a particular embodiment, the application tier 304 can include a client gateway 350 that communicates data directly to the client-facing tier 302. In this embodiment, the client gateway 350 can be coupled directly to the CFT switch 330. The client gateway 350 can provide user access to the private network 310 and the tiers coupled thereto. In an illustrative embodiment, the set-top box devices 316, 324 can access the IPTV system 300 via the access network 366, using information received from the client gateway 350. User devices can access the client gateway 350 via the access network 366, and the client gateway 350 can allow such devices to access the private network 310 once the devices are authenticated or verified. Similarly, the client gateway 350 can prevent unauthorized devices, such as hacker computers or stolen set-top box devices from accessing the private network 310, by denying access to these devices beyond the access network 366.

For example, when the first representative set-top box device 316 accesses the client-facing tier 302 via the access network 366, the client gateway 350 can verify subscriber information by communicating with the subscriber and system store 348 via the private network 310. Further, the client gateway 350 can verify billing information and status by communicating with the OSS/BSS gateway 344 via the private network 310. In one embodiment, the OSS/BSS gateway 344 can transmit a query via the public network 312 to the OSS/BSS server 364. After the client gateway 350 confirms subscriber and/or billing information, the client gateway 350 can allow the set-top box device 316 to access IPTV content and VOD content at the client-facing tier 302. If the client gateway 350 cannot verify subscriber information for the set-top box device 316, e.g., because it is connected to an unauthorized twisted pair, the client gateway 350 can block transmissions to and from the set-top box device 316 beyond the access network 366.

As indicated in FIG. 3, the acquisition tier 306 includes an acquisition tier (AQT) switch 352 that communicates with the private network 310. The AQT switch 352 can also communicate with the operations and management tier 308 via the public network 312. In a particular embodiment, the AQT switch 352 can be coupled to one or more live Acquisition-servers (A-servers) 354 that receive or acquire television content, movie content, advertisement content, other video content, or any combination thereof, from a broadcast service 356, such as a satellite acquisition system or satellite head-end office. In a particular embodiment, the live acquisition server 354 can transmit content to the AQT switch 352, and the AQT switch 352 can transmit the content to the CFT switch 330 via the private network 310.

In an illustrative embodiment, content can be transmitted to the D-servers 332, where it can be encoded, formatted, stored, replicated, or otherwise manipulated and prepared for communication from the video server(s) 380 to the set-top box devices 316, 324. The CFT switch 330 can receive content from the video server(s) 380 and communicate the content to the CPE 314, 322 via the access network 366. The set-top box devices 316, 324 can receive the content via the CPE 314, 322, and can transmit the content to the television monitors 318, 326. In an illustrative embodiment, video or audio portions of the content can be streamed to the set-top box devices 316, 324.

Further, the AQT switch 352 can be coupled to a video-on-demand importer server 358 that receives and stores television or movie content received at the acquisition tier 306 and communicates the stored content to the VOD server 336 at the client-facing tier 302 via the private network 310. Additionally, at the acquisition tier 306, the video-on-demand (VOD) importer server 358 can receive content from one or more VOD sources outside the IPTV system 300, such as movie studios and programmers of non-live content. The VOD importer server 358 can transmit the VOD content to the AQT switch 352, and the AQT switch 352, in turn, can communicate the material to the CFT switch 330 via the private network 310. The VOD content can be stored at one or more servers, such as the VOD server 336.

When users issue requests for VOD content via the set-top box devices 316, 324, the requests can be transmitted over the access network 366 to the VOD server 336, via the CFT switch 330. Upon receiving such requests, the VOD server 336 can retrieve the requested VOD content and transmit the content to the set-top box devices 316, 324 across the access network 366, via the CFT switch 330. The set-top box devices 316, 324 can transmit the VOD content to the television monitors 318, 326. In an illustrative embodiment, video or audio portions of VOD content can be streamed to the set-top box devices 316, 324.

FIG. 3 further illustrates that the operations and management tier 308 can include an operations and management tier (OMT) switch 360 that conducts communication between the operations and management tier 308 and the public network 312. In the embodiment illustrated by FIG. 3, the OMT switch 360 is coupled to a TV2 server 362. Additionally, the OMT switch 360 can be coupled to an OSS/BSS server 364 and to a simple network management protocol monitor 386 that monitors network devices within or coupled to the IPTV system 300. In a particular embodiment, the OMT switch 360 can communicate with the AQT switch 352 via the public network 312.

The OSS/BSS server 364 may include a cluster of servers, such as one or more CPE data collection servers that are adapted to request and store operations systems data, such as performance data from the set-top box devices 316, 324. In an illustrative embodiment, the CPE data collection servers may be adapted to analyze performance data to identify a condition of a physical component of a network path associated with a set-top box device, to predict a condition of a physical component of a network path associated with a set-top box device, or any combination thereof.

In an illustrative embodiment, the live acquisition server 354 can transmit content to the AQT switch 352, and the AQT switch 352, in turn, can transmit the content to the OMT switch 360 via the public network 312. In this embodiment, the OMT switch 360 can transmit the content to the TV2 server 362 for display to users accessing the user interface at the TV2 server 362. For example, a user can access the TV2 server 362 using a personal computer 368 coupled to the public network 312.

The charitable management system 130 of FIGS. 1-2 can be operably coupled to the third communication system 300 for managing charitable contributions of the subscribers of the third communication system.

It should be apparent to one of ordinary skill in the art from the foregoing media communication system embodiments that other suitable media communication systems for distributing broadcast media content and managing charitable contributions can be applied to the present disclosure.

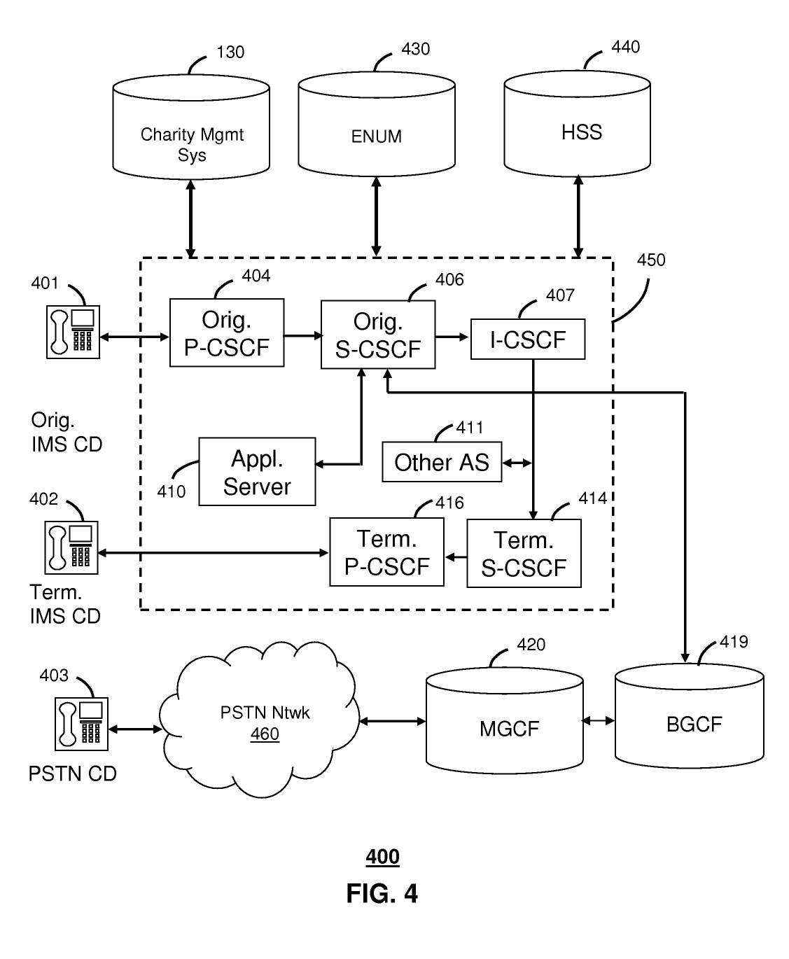

FIG. 4 depicts an exemplary embodiment of a communication system 400 employing a IP Multimedia Subsystem (IMS) network architecture. Communication system 400 can be overlaid or operably coupled with communication systems 100-300 as another representative embodiment of said communication systems.

The communication system 400 can comprise a Home Subscriber Server (HSS) 440, a tElephone NUmber Mapping (ENUM) server 430, and network elements of an IMS network 450. The IMS network 450 can be coupled to IMS compliant communication devices (CD) 401, 402 or a Public Switched Telephone Network (PSTN) CD 403 using a Media Gateway Control Function (MGCF) 420 that connects the call through a common PSTN network 460.

IMS CDs 401, 402 register with the IMS network 450 by contacting a Proxy Call Session Control Function (P-CSCF) which communicates with a corresponding Serving CSCF (S-CSCF) to register the CDs with an Authentication, Authorization and Accounting (AAA) support by the HSS 440. To accomplish a communication session between CDs, an originating IMS CD 401 can submit a SIP INVITE message to an originating P-CSCF 404 which communicates with a corresponding originating S-CSCF 406. The originating S-CSCF 406 can submit the SIP INVITE message to an application server (AS) such as reference 410 that can provide a variety of services to IMS subscribers. For example, the application server 410 can be used to perform originating treatment functions on the calling party number received by the originating S-CSCF 406 in the SIP INVITE message.

Originating treatment functions can include determining whether the calling party number has international calling services, and/or is requesting special telephony features (e.g., *72 forward calls, *73 cancel call forwarding, *67 for caller ID blocking, and so on). Additionally, the originating S-CSCF 406 can submit queries to the ENUM system 430 to translate an E.164 telephone number to a SIP Uniform Resource Identifier (URI) if the targeted communication device is IMS compliant. If the targeted communication device is a PSTN device, the ENUM system 430 will respond with an unsuccessful address resolution and the S-CSCF 406 will forward the call to the MGCF 420 via a Breakout Gateway Control Function (BGCF) 419.

When the ENUM server 430 returns a SIP URI, the SIP URI is used by an Interrogating CSCF (I-CSCF) 407 to submit a query to the HSS 440 to identify a terminating S-CSCF 414 associated with a terminating IMS CD such as reference 402. Once identified, the I-CSCF 407 can submit the SIP INVITE to the terminating S-CSCF 414 which can call on an application server 411 similar to reference 410 to perform the originating treatment telephony functions described earlier. The terminating S-CSCF 414 can then identify a terminating P-CSCF 416 associated with the terminating CD 402. The P-CSCF 416 then signals the CD 402 to establish communications. The aforementioned process is symmetrical. Accordingly, the terms “originating” and “terminating” in FIG. 4 can be interchanged.

IMS network 450 can also be operably coupled to the charity management system 130 previously discussed for FIG. 1. In this representative embodiment, the charity management system 130 can be accessed over a PSTN or VoIP channel of communication system 400 by common techniques such as described above.

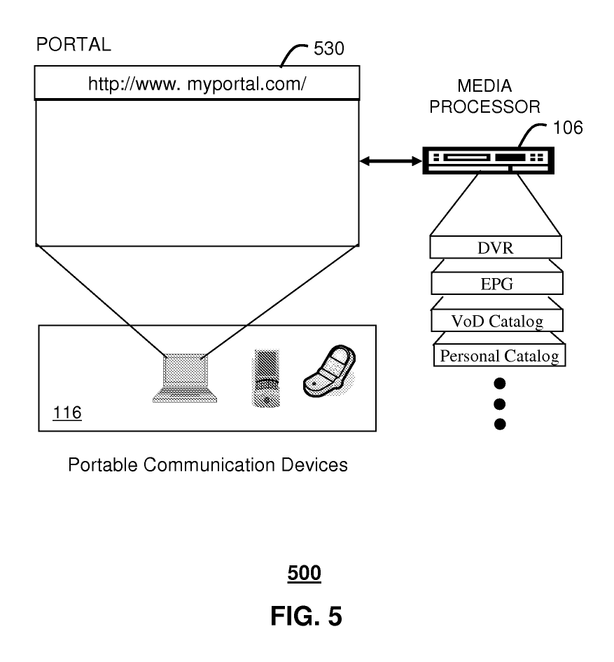

FIG. 5 depicts an exemplary embodiment of a portal 530. The portal 530 can be used for managing services of communication systems 100-400. The portal 530 can be accessed by a Uniform Resource Locator (URL) with a common Internet browser such as Microsoft's Internet Explorer using an Internet-capable communication device such as references 108, 116, or 210 of FIGS. 1-2. The portal 530 can be configured to access a media processor such as references 106, 204, 206, 316, and 324 of FIGS. 1-3 and services managed thereby such as a Digital Video Recorder (DVR), an Electronic Programming Guide (EPG), VOD catalog, a personal catalog stored in the STB (e.g., personal videos, pictures, audio recordings, etc.), and so on. The portal 530 can also be used to communicate with the charity management system 130.

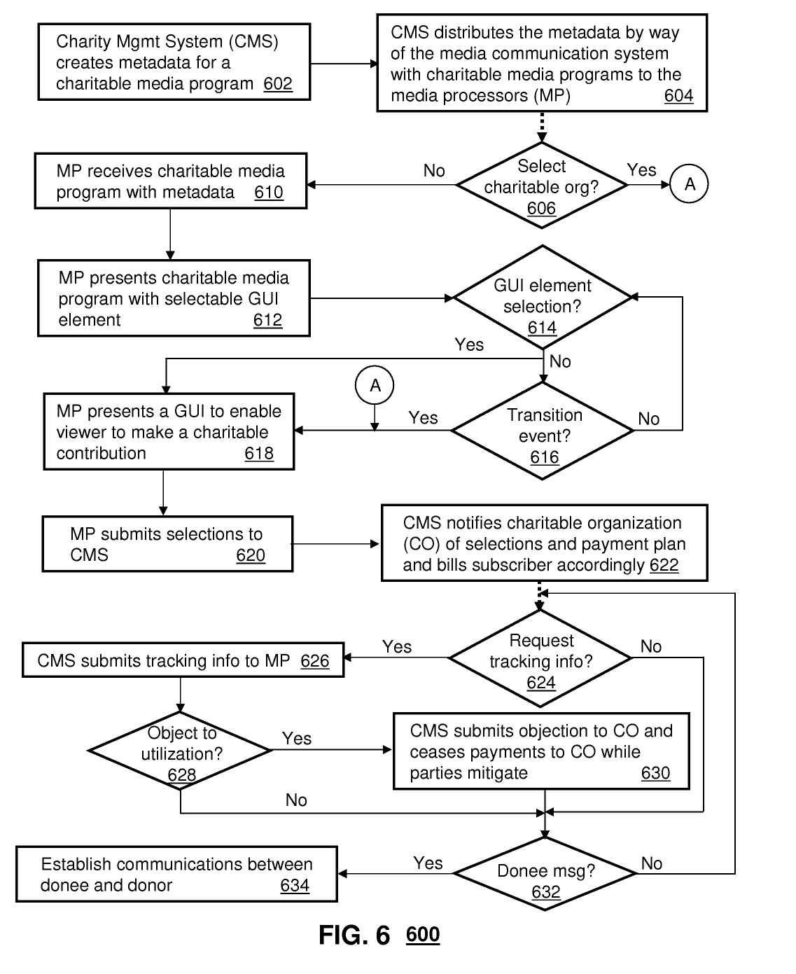

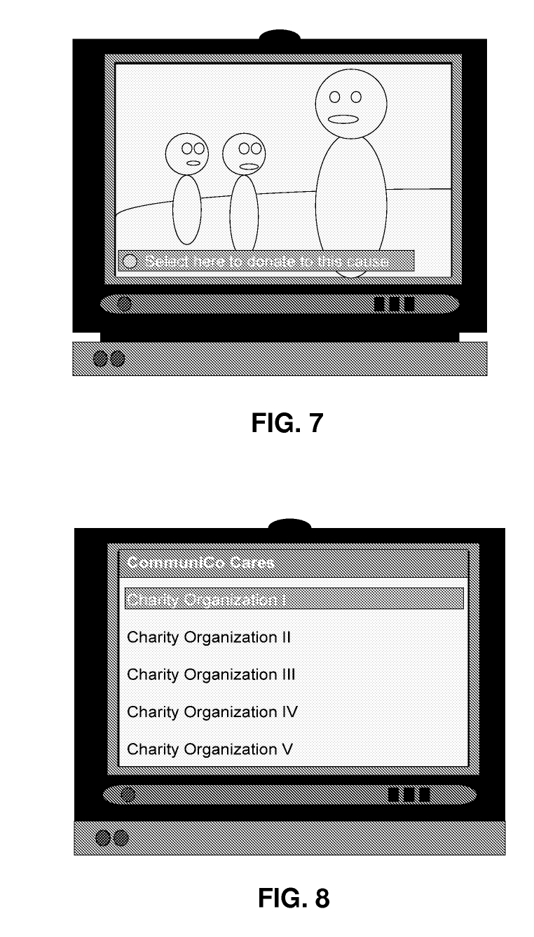

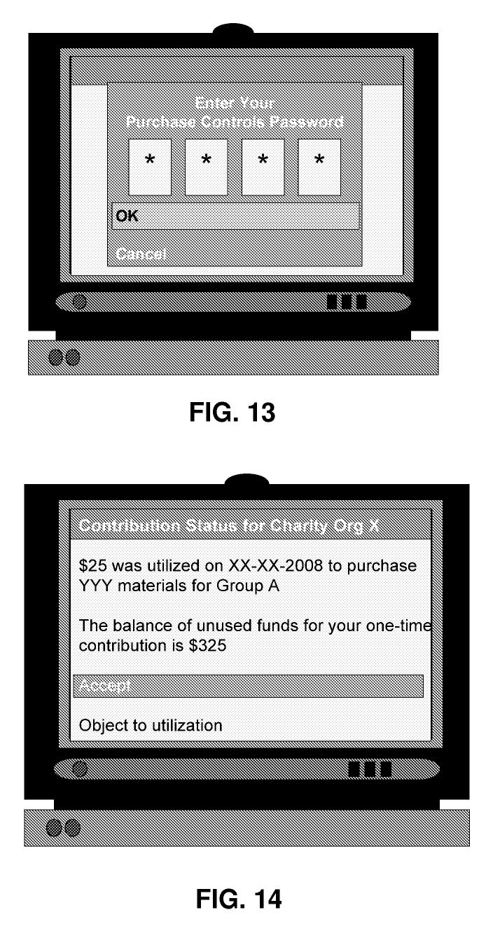

FIG. 6 depicts an exemplary method 600 operating in portions of communication systems 100-400. FIGS. 7-13 depict graphical user interfaces (GUIs) associated with the steps of method 600. Method 600 can begin with step 602 in which the charity management system (CMS) 130 creates by common means metadata describing a charitable media program. The charitable media program can represent a media program produced by a charitable organization such as the “United Way”, the “American Red Cross”, “Habitat for Humanity”, the “Lance Armstrong Foundation”, and so on. The metadata can provide for example a description of the charitable organization, one or more payment schedule options, one or more selectable recipients for receiving a charitable contribution, an option to request monitoring of the utilization of a charitable contribution by the charitable organization, and an option to request an interaction between a donor and donee.

The metadata can be distributed by the CMS 130 in step 604 by way of the media communication systems described earlier with the corresponding charitable media program for consumption at the media processors in the media communication systems. Steps 602 and 603 can represent off-line configuration activities performed by the CMS 130 and other network elements of a media communication system.

Step 606 depicts an embodiment in which some subscribers of a media processor can proactively engage in a selection of a charitable organization to make a contribution thereto as will be describe by steps 618-622. Step 606 can be triggered when for example a viewer browses through a list of charitable organizations on a presentation device managed by a media processor such as an STB of FIGS. 1-3. The media processor can be directed by the viewer using for example an “on demand” function to display a list of charitable organizations such as shown in FIG. 8. The subscriber can then selectively choose a charitable organization with common navigations buttons (such as up, down, and select) to invoke a transition from step 606 to step 618.

When a viewer chooses instead to request a presentation of a select charitable program (by for example channel navigation with a remote controller), the media processor can be directed to step 610 where it tunes into the charitable media program and thereby extracts the associated metadata, which may be embedded in the media program or supplied as an accompaniment. In step 612, the media processor can present the charitable media program at a media presentation device (such as a television or computer screen as shown in FIG. 1) with a selectable GUI element. An illustrative embodiment of this step is shown in FIG. 7.

In this illustration the background represents the charitable media program (e.g., a program showing the devastation after the Tsunami and charitable activities to help the homeless, a housing project for the poor, etc.). The media processor can be directed to superimpose on the media program a selectable GUI element such as an icon with a descriptive heading (e.g., “Select here to donate to this cause”). The icon or text can be selected by navigating a pointer with a remote control. In another illustrative embodiment, the selectable GUI element can be presented at a display of the remote controller as a softkey or other selectable item. The selectable GUI element can be detected by the media processor in step 614 from signals supplied by the remote controller. Once a signal is detected, the media processor can invoke a process for submitting a charitable contribution by way of the media processor as described by steps 618-622.

In yet another illustrative embodiment, the charitable process of steps 618-622 can be invoked by a transition event for requesting charitable contributions. The event can be for example an ending of the charitable media program detected by the media processor from metadata supplied therewith. In another illustrative embodiment the event can represent a number of interleaved events described by the metadata for purposes of requesting charitable contributions at different points in time in the charitable media program presentation. Suppose for example that the charitable media program corresponds to a 1 hour program with four intervening events for requesting a charitable contribution (one 15 minutes after the start of the program, another 35 minutes from the start, another 45 minutes from the start, and a fourth and final event at the end of the program 5 minutes before the hour expires). Each of the foregoing events can be detected in step 616 by the media processor using the metadata provided with the charitable media program.

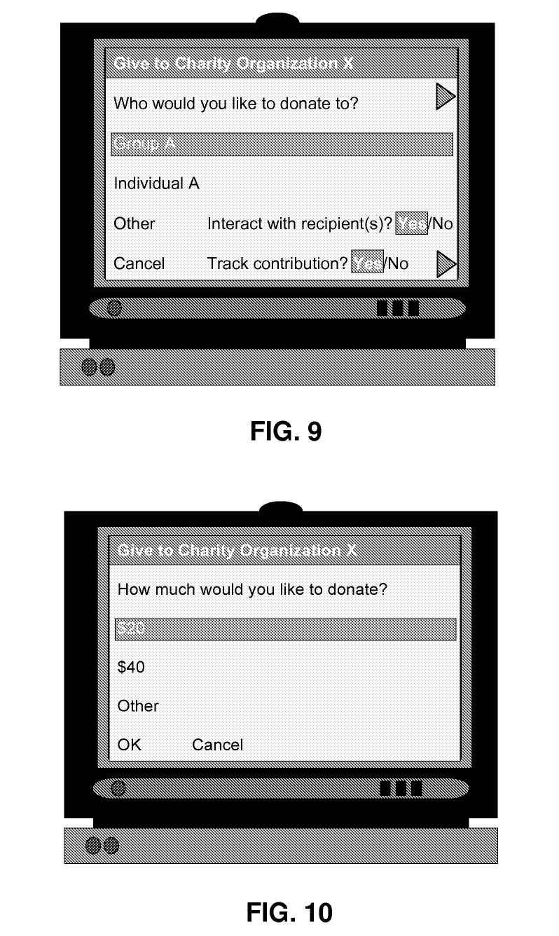

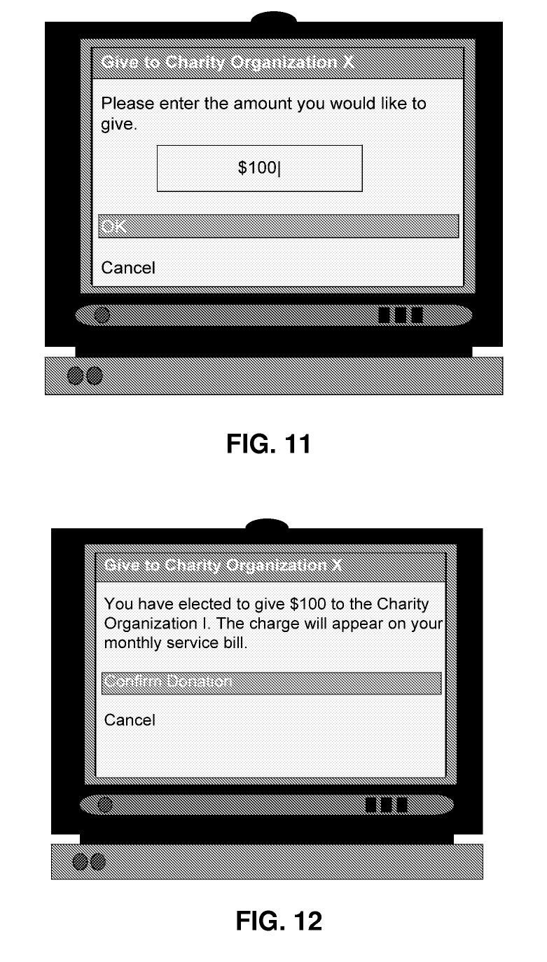

Once a GUI element selection or transition event is detected in steps 614 or 616 respectively, the media processor proceeds to step 618 to present a GUI to enable the viewer to make a charitable contribution to the charitable organization selected in step 606 or associated with the charitable media program presented in step 612. The GUI presented in step 618 can represent a number of nested GUI windows. For example, the viewer can be presented with a first GUI window as depicted in FIG. 9 that provides the user a means to direct a charitable contribution to one or more recipients (donees) with a request to track the utilization of the contribution by the charitable organization and a request to interact with the recipients of the contribution. After a recipient is selected, the media processor can be directed to present the GUI windows of FIGS. 10-11 to provide the viewer an option to select a standard donation or specify an amount responsive to selecting “Other” in the GUI of FIG. 10.

Once the recipients and the charitable contribution has been specified, the viewer can be presented with a GUI window such as depicted in FIG. 12 to confirm the selections. For security purposes, the viewer can also be asked to provide authentication information to confirm that the viewer is the subscriber of the media processor or someone who the subscriber has authorized to make the transaction. Once these selections have been made and validated, the media processor can be directed to submit the selections to the CMS 130 in step 620 and an identification of the charitable organization associated with the transaction. The CMS 130 in response can notify the charitable organization in step 622 of the selections and a payment plan of the subscriber. The CMS 130 can also direct in this step a billing system of the media communication system to bill a subscriber account associated with the media processor from which the charitable contribution was initiated in steps 618-620.

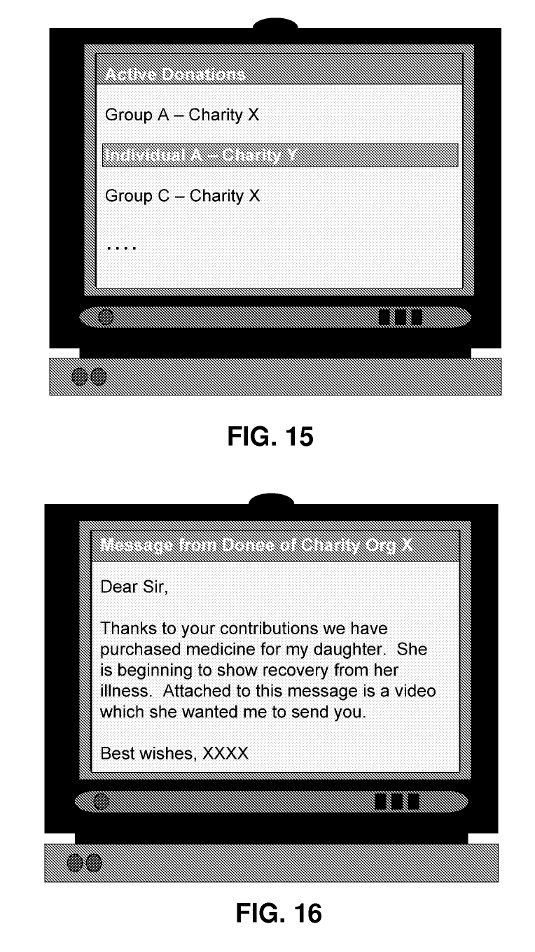

Steps 624-634 can represent non-run time steps which can occur at any time after the contribution is started. In step 624 for example the media processor can be directed to monitor a request by a subscriber/donor to receive an update on the utilization of a charitable contribution by the charitable organization. A donor can submit to the media processor the request by for example requesting presentation of a GUI (as shown in FIG. 15) listing all active donations (using for example on demand functions). The subscriber can then select one of the donations to be reviewed using the navigation controls of the remote controller.

If such a request is detected, the media processor can be directed to submit a request to the CMS 130 for tracking information associated with the selected donation and proceeds to step 626 where it receives the tracking information from the CMS. The tracking information can include among other things a description of one or more expenses applied to the charitable contribution by the charitable organization, a timing description of the one or more expenses, an identified unused balance of the charitable contribution, and/or a progress report of a targeted recipient of the charitable contribution.

FIG. 14 depicts an exemplary illustration of a GUI presented by the media processor outlining utilization information of a particular donation by a charitable organization. In this example the charitable organization spent $25 of the donor's contribution on a given date for a select recipient. A balance of $325 remain for the charitable organization to utilize for other charitable activities pertaining to recipient/donee (Group A in this illustration). The media processor can be directed in step 628 to determine if the subscriber accepts or objects to the utilization of the contribution by the charitable organization. If there is an objection, the media processor can be directed to step 630 where it informs the CMS 130 of the objection and the CMS submits the objection to the charitable organization and ceases payments thereto until the subscriber and the charitable organization mitigate the objection.

The media processor can also be directed in step 632 to monitor donee messages and establish communications therebetween in step 634 when warranted. The communications can be active bilateral communications such as voice or video messaging (e.g., VoIP call), or text messaging (e.g., instant messaging). In another illustrative embodiment communications can be unilateral non-real-time communications such as email, SMS or MMS messages, messages posted by way of the portal 530 and so on. The communications between the subscriber and recipient can be managed by the CMS 130 or can be performed directly between the media processor and a communication device managed by the recipient and/or the charitable organization.

Upon reviewing the aforementioned embodiments, it would be evident to an artisan with ordinary skill in the art that said embodiments can be modified, reduced, or enhanced without departing from the scope and spirit of the claims described below. For example, method 600 can be adapted so that less GUI windows are presented in step 618 by consolidating options, providing a scrollable window, or by other suitable methods. In another illustrative embodiment, payments can be selected by a subscriber according to a recurring payment schedule in lieu of a one-time payment. In yet another illustrative embodiment, tracking information can be delivered directly to the media processor from the charitable organization without assistance from the CMS 130. In another illustrative embodiment, mitigation between the subscriber/donor and the charitable organization can be mediated by service personnel of the media communication system. In yet another illustrative embodiment, the subscriber account charged with the contribution can be a subscriber account unassociated with the media processor from which the contribution was made. Associating a contribution to a subscriber account can be accomplished a number of ways. For example, the authentication data provided in step 618 can identify any subscriber of the media communication system not just the subscriber of the media processor managing the charitable transaction. Accordingly a subscriber of the media communication system can make a contribution from any media processor by providing authentication information that uniquely identifies the subscriber.

Other suitable modifications that can be applied to the present disclosure without departing from the scope of the claims below. Accordingly, the reader is directed to the claims section for a fuller understanding of the breadth and scope of the present disclosure.

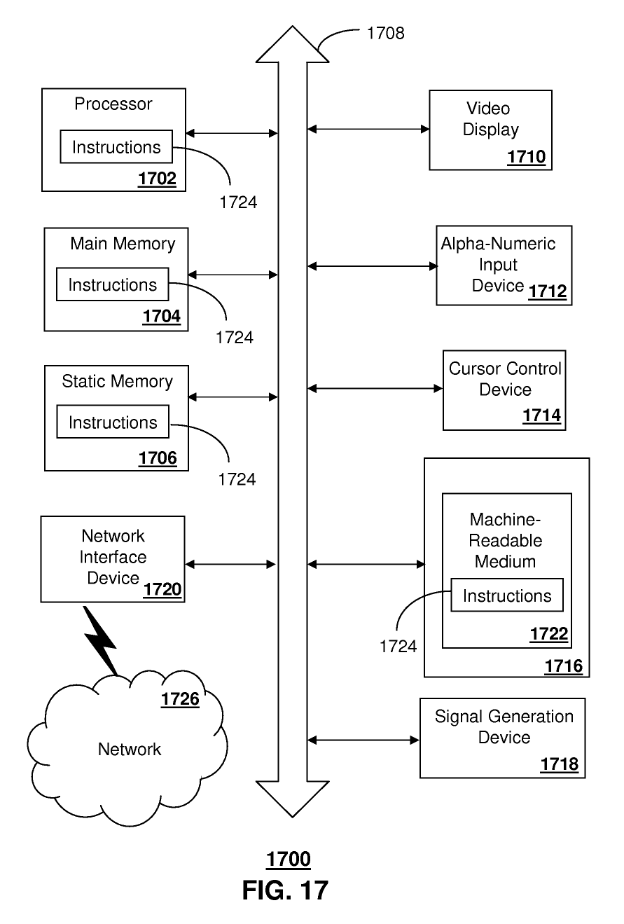

FIG. 17 depicts an exemplary diagrammatic representation of a machine in the form of a computer system 1700 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 1700 may include a processor 1702 (e.g., a central processing unit (CPU), a graphics processing unit (GPU, or both), a main memory 1704 and a static memory 1706, which communicate with each other via a bus 1708. The computer system 1700 may further include a video display unit 1710 (e.g., a liquid crystal display (LCD), a flat panel, a solid state display, or a cathode ray tube (CRT)). The computer system 1700 may include an input device 1712 (e.g., a keyboard), a cursor control device 1714 (e.g., a mouse), a disk drive unit 1716, a signal generation device 1718 (e.g., a speaker or remote control) and a network interface device 1720.

The disk drive unit 1716 may include a machine-readable medium 1722 on which is stored one or more sets of instructions (e.g., software 1724) embodying any one or more of the methodologies or functions described herein, including those methods illustrated above. The instructions 1724 may also reside, completely or at least partially, within the main memory 1704, the static memory 1706, and/or within the processor 1702 during execution thereof by the computer system 1700. The main memory 1704 and the processor 1702 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 1724, or that which receives and executes instructions 1724 from a propagated signal so that a device connected to a network environment 1726 can send or receive voice, video or data, and to communicate over the network 1726 using the instructions 1724. The instructions 1724 may further be transmitted or received over a network 1726 via the network interface device 1720.

While the machine-readable medium 1722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A set top box (STB) operating in an interactive television communication system, comprising a controller to:
receive metadata describing a charitable media program associated with a charitable organization;
present images of the charitable media program and a selectable graphical user interface (GUI) element;
detect a transition event in the presentation of the charitable media program according to the metadata or a selection of the GUI element; and
present a GUI to enable a viewer to make a charitable contribution by way of the STB.

2. The STB of claim 1, wherein the transition event corresponds to an event for requesting charitable contributions, wherein the viewer is a subscriber of a media communication system from which the STB operates, and wherein the media communication system comprises at least one among an Internet Protocol Television (TV) communication system, a cable TV communication system, a satellite TV communication system, a Public Switched Telephone Network (PSTN), a Voice over IP (VoIP) communication system, and an IP Multimedia Subsystem combining the PSTN and VoIP communication systems.

3. The STB of claim 1, wherein the controller is adapted to:
detect in the GUI an entry for a charitable contribution;
identify from the metadata the charitable organization associated with the media program; and
notify a media communication system from which the STB operates of a request to make one or more payments to the charitable organization from an account of a subscriber of the STB.

4. The STB of claim 3, wherein the controller is adapted to present in the GUI at least one among a description of the charitable organization, one or more payment schedule options, one or more selectable recipients for receiving a charitable contribution of the subscriber, a selectable request to track utilization of a charitable contribution by the charitable organization, and a selectable request to interact with a select one of the one or more selectable recipients.

5. The STB of claim 4, wherein the controller is adapted to:
detect a selection in the GUI of a targeted recipient for a charitable contribution of the subscriber; and
notify at least one of the media communication system or the charitable organization of the targeted recipient of the charitable contribution.

6. The STB of claim 4, wherein the controller is adapted to:
detect a selection in the GUI to track utilization of charitable contribution by the charitable organization; and
notify at least one of the media communication system or the charitable organization of the request to track the utilization of charitable contribution.

7. The STB of claim 6, wherein the controller is adapted to:
receive information relating to the utilization of the charitable contribution by the charitable organization; and
notify the subscriber of the utilization information.

8. The STB of claim 7, wherein the information is received from the media communication system or the charitable organization.

9. The STB of claim 6, wherein the controller is adapted to:
receive a request from the subscriber for a status of the utilization of the charitable contribution by the charitable organization; and
present a GUI with the received utilization information.

10. The STB of claim 6, wherein the utilization information comprises at least one among a description of one or more expenses applied to the charitable contribution, a timing description of the one or more expenses, an identified unused balance of the charitable contribution, and a progress report of a targeted recipient of the charitable contribution.

11. The STB of claim 5, wherein the controller is adapted to:
detect a selection in the GUI to interact with the targeted recipient; and
notify at least one of the media communication system or the charitable organization of the request to interact with the targeted recipient.

12. The STB of claim 11, wherein the controller is adapted to exchange messages between the targeted recipient and the subscriber.

13. The STB of claim 12, wherein the controller is adapted to:
receive from one among the media communication system, the charitable organization, and the targeted recipient one or more messages of the targeted recipient directed to the subscriber; and
transmit to one among the media communication system, the charitable organization, and the targeted recipient one or more messages of the subscriber directed to targeted recipient.

14. The STB of claim 12, wherein the messages are exchanged over a bilateral communication session established between the targeted recipient and the subscriber or a unilateral communication session initiated by the targeted recipient or the subscriber, and wherein the exchanged messages comprise one among audio messages, text messages, video messages, and combinations thereof.

15. The STB of claim 1, wherein the images of the charitable media program are presented at a media presentation device, wherein the media presentation device comprises a computer display or a television display, and wherein the selectable GUI element is presented at the media presentation device or a remote controller managing operations of the STB.

16. A charity management system (CMS), comprising a controller to:
collect metadata of a charitable media program associated with a charitable organization;
distribute the metadata to one or more media processors operating in an interactive television communication system to facilitate presentation of an interactive charitable contribution graphical user interface;
receive from one of the media processors a request to make a contribution to the charitable organization;
identify a subscriber account of the requesting media processor;
submit one or more payments to the charitable organization; and
record the one or more payments in the subscriber account.

17. The CMS of claim 16, wherein a subscriber of the media processor receives from a service provider of a media communication system from which the media processor and the CMS operate a billing statement comprising in part the one or more payments made to the charitable contribution.

18. The CMS of claim 16, wherein the controller is adapted to:
receive from the media processor a request to direct the contribution to a targeted recipient; and
notify the charitable organization to direct the contribution to the targeted recipient.

19. The CMS of claim 16, wherein the controller is adapted to:
receive from the charitable organization information describing a utilization of the contribution by the charitable organization; and
submit the utilization information to the media processor.

20. The CMS of claim 19, wherein the controller is adapted to:
receive from the media processor an objection to the utilization of the contribution; and
cease submission of additional payments to the charitable organization.

21. The CMS of claim 16, wherein the controller is adapted to request authentication information from a subscriber of the media processor to enable the one or more payments to the charitable organization.

22. A method, comprising a charitable organization receiving a charitable contribution from a subscriber account of an interactive television (iTV) communication system.

23. The method of claim 22, comprising the charitable organization receiving the charitable contribution responsive to a subscriber associated with the subscriber account submitting a request to the iTV communication system to initiate the charitable contribution.

24. The method of claim 22, comprising:
the charitable organization submitting to the iTV communication system information associated with a utilization of the charitable contribution;
the charitable organization receiving from the iTV communication system a notice indicating an objection to the utilization; and
the charitable organization mitigating the objection.

25. The method of claim 22, comprising the charitable organization establishing communications by way of the iTV communication system between a recipient of the contribution and a subscriber of the iTV communication system.
